(19) United States
(12) Patent Application Publication
(10) Pub. No.: US 2021/0174627 A1
(43) Pub. Date: Jun. 10, 2021

(54) Methods to Reduce Jamming in a Drum Style Bill Handler and Recycler

(71) Applicant: JCM American Corporation, Las Vegas, NV (US)

(72) Inventor: Dave Kubajak, Las Vegas, NV (US)

(21) Appl. No.: 16/909,653

(22) Filed: Jun. 23, 2020

Related U.S. Application Data
(60) Provisional application No. 62/946,170, filed on Dec. 10, 2019.

(51) Int. Cl. G07D 11/18; G07D 11/237; G07D 7/181; G07D 11/23

(52) U.S. Cl. CPC G07D 11/18; G07D 11/237; G07D 11/175; G07D 11/23; G07D 7/181

(57) ABSTRACT

Disclosed herein are currency handling devices, systems, and methods of their operation to reduce jamming. The currency handling devices may make use of bank note recycling, in which received notes are stored on a drum recycler and subsequently dispensed. The devices and methods may move notes from the drum recycler to either an escrow section or into a storage area, based on an amount of wear or deformation of the notes. Notes moved into the escrow section may subsequently be replaced on the drum recycler. The methods may be initiated manually, on a scheduled basis, based on sensor readings, or otherwise.

### CROSS-REFERENCE TO RELATED APPLICATION

This application is a nonprovisional of and claims the benefit under 35 U.S.C. § 119(e) of U.S. Provisional Patent Application No. 62/946,170, filed Dec. 10, 2019, the contents of which are incorporated herein by reference.

### FIELD

The present disclosure generally relates to currency handling devices that both accept and dispense bank notes or bills to users. Such currency handling devices may involve the receipt, movement, storage, and dispensing of the bank notes. Devices, systems, and methods are presented herein for configuration and operation of such currency handling devices to reduce jamming of bills during movement.

### BACKGROUND

Many business establishments, such as casinos, provide currency handling devices or machines for the convenience of their customers. Such currency handling devices may accept and/or dispense bank notes (herein also “bills” or “currency”). The currency handling devices may also accept and/or dispense other types of documents, such as casino gaming tickets, coupons, personal checks, and the like. The currency handling devices may also provide other services as well, such as electronic funds transfers within, or between, financial institutions.

Some currency handling devices may store bills, such as those received from a user, in a section for return or disbursement, such as to a later user. Currency handling devices with such storage and return capability may be provided by gaming establishments, such as casinos, that have high currency usage and turnover. A storage and return capability may reduce a need to empty or reload bills, as would be the case for a currency handling device in which received bills were only stored in a first section until removed, and dispensed bills were separately provided from a second section. However, many currency handling devices capable of storing and subsequent dispensing of bills may have mechanical paths or slots along which the bills are received, and dispensed and, often, such paths become jammed or clogged during bill movement.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

Disclosed herein are currency handling devices (or “currency handling machines”), systems including currency handling devices, and methods for their operation. The currency handling devices described herein make use of bank note recycling, in which received bank notes, such as may be received from a user, are stored and subsequently dispensed or issued to the same or a different user.

More specifically, methods of operating currency handling devices are described for currency handling devices that include a bill recycler, a bill storage area, and an escrow section. The methods include the operations of: moving a bill from the bill recycler to the escrow section; determining whether the bill is to be moved to the bill storage area; moving the bill from the escrow section to the bill storage area in the case that it is determined that the bill is to be moved to the bill storage area; and moving the bill from the escrow section to the bill recycler in the case that it is determined that the bill is not to be moved to the bill storage area.

In additional and/or alternative embodiments, the methods include iterating these operations for multiple bills stored on the bill recycler. Signals to initiate the operations may be operator-applied, periodically applied, or automatically generated.

Also described herein is a currency handling device that includes: a bank note acceptor; a bill recycler with at least one storage and recycling (S/R) drum; an escrow section with an escrow storage drum; and a bill storage area. The currency handling device is operable to perform a set of operations that: move the bank note from the bill recycler to the escrow section; determine whether the bank note is to be moved to the bill storage area; move the bank note from the escrow section to the bill storage area in the case that it is determined that the bank note is to be moved to the bill storage area; and move the bank note from the escrow section to the bill recycler in the case that it is determined that the bank note is not to be moved to the bill storage area. The currency handling device may be operable to dispense bank notes from the bill recycler. The currency handling device may include a bill validator to determine to which of the bill recycler and the bill storage area the bank note is to be routed.

In additional and/or alternative embodiments, the currency handling devices include a control unit operably linked with the bill recycler and the escrow section, and operable to coordinate the performance of the set of operations. The control unit may be connected to an external control center. The currency handling devices may include a sensor to detect an environmental condition within the currency handling device. The detected environmental conditions may be used, either by an operator or automatically by the control unit, to adjust the timing or initiation of the bank note recycling methods.

### BRIEF DESCRIPTION OF THE DRAWINGS

The disclosure will be readily understood by the following detailed description in conjunction with the accompanying drawings, wherein like reference numerals designate like structural elements.

FIG. 1A illustrates components of a currency handling device that includes a drum style bank note recycler.

FIG. 1B illustrates side views of deformations that may occur to a bank note stored on a drum style bank note recycler.

FIG. 2A illustrates a first example configuration of components of a currency handling device.

FIG. 2B illustrates a second example configuration of components of a currency handling device.

FIG. 3 illustrates a block diagram of components of a currency handling device.

FIG. 4 shows a flow chart of a method of operating a currency handling device.

FIG. 5 illustrates a signal flow chart of a method for issuing a command to move bank notes in a currency handling device.

FIGS. 6A-6C illustrate a sequence of movements of bank notes in a currency handling device.

FIG. 7 illustrates a sequence of movements of a bank note in a currency handling device.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented there between, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The embodiments described herein are directed to currency handling devices that accept (take in) bank notes or bills, or other types of documents, and store at least some for return to users. Examples of such other types of documents include, but are not limited to, casino gaming tickets, coupons, and personal checks. By storing, at least temporarily, some received bills or documents, there may be less need to reload the currency handling device, such as with bills, for dispensing to users. The currency handling devices may be part of, or also include, a printing device operable to dispense documents, such as casino gaming tickets, coupons, and personal checks.

As an example, such a currency handling device may also accept credit, bank cards, or debit cards, coins, or other forms of payment, and may be equipped to execute transfers of money from a user's financial account (e.g., bank account, credit account, and so on). The currency handling device may then dispense an entered amount from the stored bills. In another example, such a currency handling device may be located in a gaming establishment, such as a casino. The currency handling device may be equipped to accept bills from a user and issue a gaming ticket (e.g., a printed object with a code readable by the casino's gaming machines) for use by the user. Further, the currency handling device may accept the bills and credit the amount to a financial account of the user. Alternatively, such a currency handling device may accept the gaming ticket and refund its associated value, or a portion thereof, by dispensing bills in one or more currencies.

In locations in which a currency handling device may be expected to be frequently accessed by users, such as casinos, recycling bills by accepting them as inputs and storing them for later dispensing back to users can reduce the number of times that it needs to have bills reloaded.

A currency handling device configured for such bill recycling may store bills by rolling or wrapping the inserted bills sequentially as they are received around a circumference of an internal storage and recycling (“SIR”) drum. As an example, the S/R drum may be a cylinder around which the bills are wrapped, analogous to paper towels wrapped around a tube.

When a bill is later needed for dispensing to a user, the outermost stored bill on an S/R drum can be unwrapped and ejected. Such a currency handling device may have multiple bill recycler sections, each with one or more such S/R drums. The multiple S/R drums in the bill recycler sections may allow for storage of separate denominations on separate S/R drums, to have back up S/R drums for the same denomination, or for other uses.

Bills that are wrapped around an S/R drum may, such as when left on the drum for an extended period of time, become deformed in various ways. For example, the bills can take the shape, if only partially, of the curvature of the S/R drum. This may increase the likelihood that such a bill would jam in an ejection conveyor subsystem of the currency handling device. Environmental factors, such as humidity and/or temperature, may contribute to an increased likelihood that a bill would jam. For example, increased temperature, or low humidity, may reduce a pliability of a bill.

The embodiments disclosed herein are directed to currency handling devices configured to reduce such a risk of jamming, and methods of their operation. The embodiments make use of an extra storage area, referred to herein as an escrow section, to which bills may be temporarily moved from an S/R drum. The bills so removed from an S/R drum may be selected to be sent either back from the escrow section to the S/R drum for storage and dispensing, or to a permanent storage area that does not dispense the bills. The selection may be based on scans or other tests of the bills, and may use a variety of criteria, such as lack of wear, recorded time a bill has been on an S/R drum, and environmental factors. The selection may be performed either as the bills are removed from the S/R drum, or as the bills are removed from the escrow section.

Such bill recycling methods of moving bills off an S/R drum to the escrow section, sorting, and restoring selected bills to the S/R drum may be implemented in various ways. The bill recycling method may be performed when a manually entered command is received, at programmed time intervals, and/or automatically based on observed factors (such as humidity or temperature, material of the bill, recorded times bills have been on the S/R drum, and so on) that can influence deformation of a bill on an S/R drum. These and other ways will be described in more detail below.

Bills removed from an S/R drum to the escrow section during a bill recycling operation may be temporarily stored around an escrow section drum, and may also be wrapped with an opposite curvature around the escrow section drum. This may reduce any curvature imparted to the bill while it was stored on the S/R drum. Alternatively, bills moved to the escrow section may be temporarily stored flat, and may then be returned to the S/R drum using a first-in, first-out (FIFO) mechanism. This may reduce chances that a bill is stored for too much time as an innermost bill wrapped on the S/R drum.

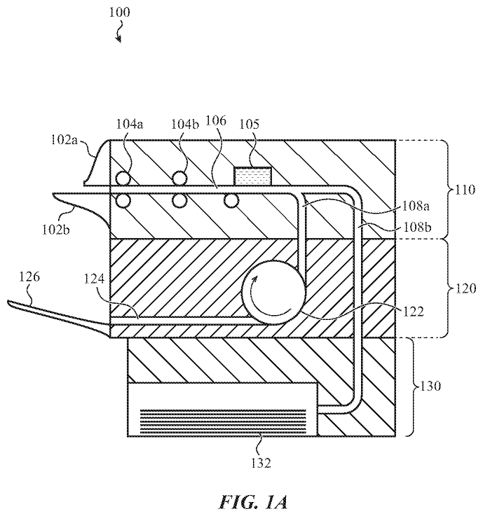

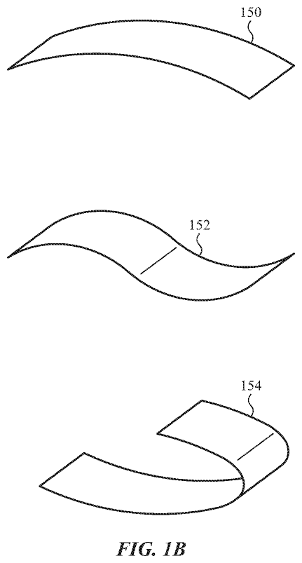

These and other embodiments are discussed below with reference to FIGS. 1A-7. However, those skilled in the art will readily appreciate that the detailed description given herein with respect to these Figures is for explanatory purposes only and should not be construed as limiting. Other examples and implementations are within the scope and spirit of the disclosure and appended claims. For example, features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). Further, the terms “example” or “exemplary” do not mean that the described example is preferred or better than other examples.

FIG. 1A illustrates components of a currency handling device 100. In general, a currency handling device may include at least the following three sections: a bill or bank note acceptor 110 (or just “bill acceptor”), a bill recycler 120, and a bill storage area 130. The particular arrangement of these sections shown in FIG. 1A, and likewise for other arrangements shown in this disclosure, is only for descriptive purposes, and does not imply a necessary physical arrangement. The currency handling device 100 shown in FIG. 1A is a simplification shown for ease of discussion of those three sections. Further, though shown as separate block components for ease of description, it is to be understood that these sections, and their internal components or parts as to be described, may be combined or formed as single units. For example, the bank note acceptor 110 and the bill recycler 120 may be a single module.

The bank note acceptor 110 receives bank notes (“bills” or “currency”) inserted by a user into the bill receiving components 102a, 102b, that form a slot or inlet. At least one of the bill receiving components 102a, 102b may have a display (e.g., alphanumeric) or other signaling components (such as LED lights) to indicate a status of the bank note acceptor, or one or more messages related to an inserted bill. The bottom bill receiving component 102b may form a tray, and may have other functional components. An inserted bill may be guided and/or moved into the interior of the bank note acceptor 110 by rollers 104a, 104b along the channel 106. Though only two rollers are labeled, the bank note acceptor 110 may have more or fewer rollers, or other configurations and/or alternative components, for moving a bill into the bank note acceptor 110.

The bank note acceptor 110 may include bill validating components, such as the bill scanner 105, to determine characteristics of an inserted bill. Such characteristics include, but are not limited to, authenticity status, denomination, value, country of origin, and wear status. If a bill is validated, it can be further processed, such as by being moved to the bill recycler 120 or the bill storage area 130. If a bill is found not valid or unacceptable, such as by wear that makes its characteristics indeterminate, it can be returned. If an inserted is bill is determined to be counterfeit, it can be moved to a containment area (not shown) within the currency handling device 100, and a message can be sent to an operator.

After an inserted bill is validated, a selection process may be used to determine to which of the bill recycler 120 or the bill storage area 130 it should be sent. The selection may be made based on a variety of criteria that may include, but are not limited to, the number of bills already in the bill recycler 120, the wear of the bill, the denomination of the bill, and the number of bills in the bill storage area 130. Once the selection process determines where to send the bill, the bill may be moved or routed either through channel 108a to be stored into the bill recycler 120 or through the channel 108b into the bill storage area 130. In some embodiments, the bank note acceptor 110 may include a mechanical switch (not shown) to guide the bill into the correct channel.

The bank note acceptor 110, or another component of the currency handling device 100, may have other inputs (not shown) in addition to the slot formed by the bill receiving components 102a and 102b. Examples of such other inputs include card readers that accept credit or debit cards configured to read identification chips or magnetic strips thereon. Still other examples include optical or visual sensors or code readers, such as bar code or QR code readers. Still other input mechanisms for receiving inputs, whether as inserts or as communications from users, may be included in the currency handling device 100. Additionally and/or alternatively, the input of the bank note acceptor 110 formed by the bill receiving components 102a and 102b may itself be operable for accepting other inputs, such as credit or debit cards, in addition to bank notes.

The second section shown, the bill recycler 120, is configured to store received bills, and may also be operable to dispense stored bills to users. In the example configuration shown, the bank note acceptor 110 can move a bill into the bill recycler 120 through the channel 108a. Though the bill recycler 120 is shown as below the bank note acceptor 110, it may be located beside, above, or in another position relative to the bank note acceptor 110.

The bill recycler 120 may include an S/R drum 122. A first bill being moved along the channel 108a may be wrapped around the S/R drum 122 as the S/R drum 122 rotates. Further bills subsequently being moved along the channel 108a may then also be wrapped onto the S/R drum 122, and be wrapped outermost from, and perhaps atop, the first bill. Multiple bills may thus be sequentially stored onto the S/R drum 122. The bill recycler 120 may use mechanisms to ensure that multiple bills become wrapped approximately evenly around the S/R drum 122. For example, leading ends of a bill being wrapped onto the S/R drum may be sequentially spaced by a fixed angular separation.

The bill recycler 120 may be configured to dispense bills from the S/R drum 122 through the channel 124, such as to a user. An exterior bezel or tray 126 may be positioned to receive the dispensed bill. Various mechanisms, as known to one skilled in the art, may be used to uncoil and/or remove the outermost bill wrapped on the S/R drum 122, and move it into the channel 124 for dispensing.

The bill recycler 120 may be equipped with counters and/or sensors to determine how many bills are stored on the S/R drum 122. As an example, the bill recycler 120 may have optical sensors detecting a thickness of all the bills wrapped on the S/R drum 122. Additionally and/or alternatively, the currency handling device 100 may have a control or processing unit that records both the number of bills received and stored onto the S/R drum 122 and the number of bills dispensed in order to maintain a count of the net number of bills stored on the S/R drum 122.

The currency handling device 100 may have a bill storage area 130 in addition to the bill recycler 120. The currency handling device 100 may have control or processing units that determine if an input bill is to be moved to the bill recycler 120 or the bill storage area 130. An input bill may be moved to the bill storage area 130 for any of various reasons, including the S/R drum 122 of the bill recycler 120 is at or near capacity, the bill is valid but not in acceptable condition for storing on the S/R drum 122, and other reasons.

Bills may be moved along a channel 108b into the bill storage area 130. The bill storage area 130 may store such bills in any of a variety of configurations, such as in a flat stack 132, loosely in a removable sack, or in another configuration.

The currency handling device 100 may have various locking mechanisms to ensure only authorized operators may remove the bills either from the bill recycler 120 or the bill storage area 130, or open any section for maintenance.

As mentioned, the currency handling device 100 is a simplified version presented for purposes of explanation and discussion. Other versions of a currency handling device may include multiple bill recycler sections, any of which may have multiple S/R drums for storing and dispensing bills. There may be one S/R drum for each denomination of bank note.

FIG. 1B shows side views of deformations of bills that may occur, such as from being stored too long on a storage drum of a drum recycler, such as on the S/R drum 122 of bill recycler 120. It may happen that a bill stored on the S/R drum 122 may have its substrate material deform to the first curled configuration 150 from an initial and/or preferred flat form. Various denominations of bills of various countries may use different substrate materials. Examples include, but are not limited to, cotton, flax, linen, and paper. When so deformed, the bill may be more likely to catch or jam in a channel, or in another location, as it is being removed from the S/R drum for dispensing.

Other forms of deformation of a bill are also possible. A second curled configuration 152 may occur when the bill's substrate has a first part deformed with a curl in a first direction, and a second part with a curl formed in the opposite direction. The second curled configuration may be produced, for example, by different speeds of movement of the bill over rollers in movement channels. Another deformation pattern of a bill that can lead to jamming is the “egged” deformation 154. A bill may have another deformation pattern. Any deformation of a bill has the potential to cause it to jam during a movement operation.

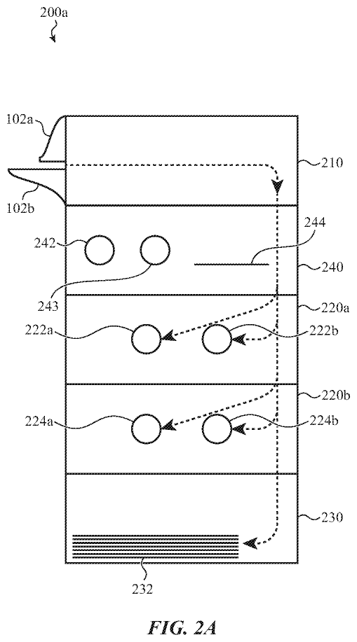

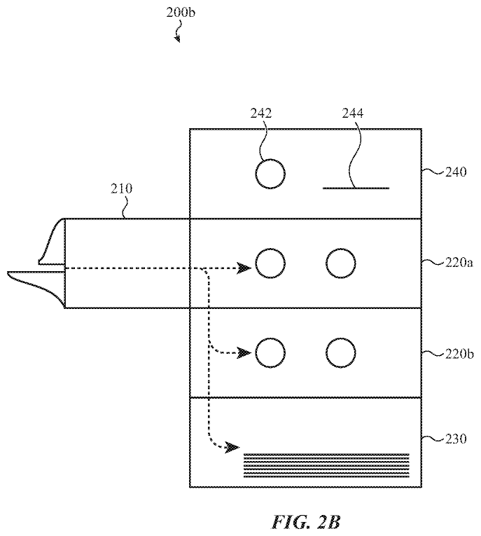

FIG. 2A illustrates an example configuration of a currency handling device 200a. The currency handling device 200a includes a bank note acceptor 210 configured to accept bank notes or other inputs from users. The bank note acceptor 210 may have any combination of features as described for the bank note acceptor 110.

The currency handling device 200a includes two bill recyclers 220a and 220b configured to receive bank notes passed from the bank note acceptor 210. The bill recycler 220a is shown with two S/R drums, 222a and 222b, and the bill recycler 220b is shown with two S/R drums 224a and 224b. Each of the S/R drums may be configured to a particular denomination of bill, such as $1.00 bills on S/R drum 222a, $5.00 bills on S/R drum 222b, $10.00 bills on S/R drum 224a, and so on Various channels and switching mechanisms (not shown) may be included in the bill recyclers 220a and 220b to route the bills to the appropriate S/R drum. The bill recycler 220a may also have channels (not shown) by which bills on the S/R drums 222a, 222b may be returned externally to a user, such as by ejection through the bill receiving components 102a and 102b of the bank note acceptor 210, or an opening separate from the bank note acceptor 210. The same components may also be included in the bill recycler 220b. One skilled in the art will recognize that in other embodiments a currency handling device may have more or fewer bill recyclers, each of which may include more or fewer than two S/R drums.

The currency handling device 200a includes a bill storage area 230. The bill storage area 230 may be configured to receive bills from the bank note acceptor 210 that are deemed (such as by a bill reader or scanner, such as bill scanner 105) unacceptable for storage on an S/R drum. Examples of criteria by which a bill or bank note would be deemed unacceptable include tears, state of wear, a denomination too large to risk jamming on a return or dispensing, a valid but foreign currency bank note, or other criteria. The bill storage area 230 may store the bills in a stack 232, loosely (such as in a secure bag), or in another way. The currency handling device 200a may include more than one bill storage area 230.

The currency handling device 200a includes an escrow section 240 configured to receive bills from the bill recyclers, as will be explained further below. The escrow section 240 shown includes two escrow storage drums 242 and 243 around which bills from the bill recyclers 220a and 220b can be stored. In other embodiments, the escrow section 240 may have one or more than two escrow storage drums.

Additionally and/or alternatively, the escrow section 240 may also have an alternative bill storage component 244 on which bills from the bill recyclers 220a and 220b may be stored in a flat stack. The alternative bill storage component 244 may use a first-in, first-out storage process. For example, bills from the S/R drum could be added to the top of a stack of bills on the alternative bill storage component 244, and removed from the bottom. In this way, the order in which the bills were stored on the S/R drum would be returned to the S/R drum in reverse order. This may serve to reduce the likelihood that bills remain on the S/R drum for too long.

During the methods described below for moving bills from the bill recyclers 220a and 220b to the escrow section 240, only some bills may need to be moved, so that either or both of the escrow storage drums 242 and 243 or the alternative bill storage component 244 may be configured to store fewer bills than the S/R drums 222a/b and 224a/b. The escrow section 240 may contain more or fewer than two escrow storage drums, and may contain multiple alternative bill storage components.

FIG. 2B illustrates a currency handling device 200b having an alternate configuration of sections than the configuration of currency handling device 200a. The currency handling device 200b similarly includes a bank note acceptor 210, two bill recyclers 220a and 220b, bill storage area 230, and an escrow section 240. In the configuration shown, the escrow section 240 has a single escrow storage drum 242 and a single alternate bill storage component 244. Each of these sections may be as described previously, or may have more or fewer components based on the alternate configuration.

Depending on the size (e.g., vertical height) of the two bill recyclers 220a and 220b and the bill storage area 230, and the height of a base on which the entire currency handling device 200b is mounted, it may be ergonomically advantageous to position the bank note acceptor in front of the top bill recycler 220a to be conveniently positioned for users. This may be possible in embodiments in which the various sections are separable units having various ways of being combined. The shown configuration of currency handling device 200b may also allow two bill recyclers 220a and 220b, the bill storage area 230, and the escrow section 240 to be positioned on one side of a secure wall, with only the bank note acceptor 210 extending through the secure wall to be user accessible.

As previously described, the bank note acceptor 210 may be configured to accept, and perhaps also validate, bills inserted by a user, and route the bills (as shown by the dotted arrows) to either an appropriate S/R drum of either bill recycler 220a or 220b, or to the bill storage area 230. As described below, the escrow section 240 may be configured to receive bills from the bill recyclers 220a and 220b, and then restore some or all of the bills.

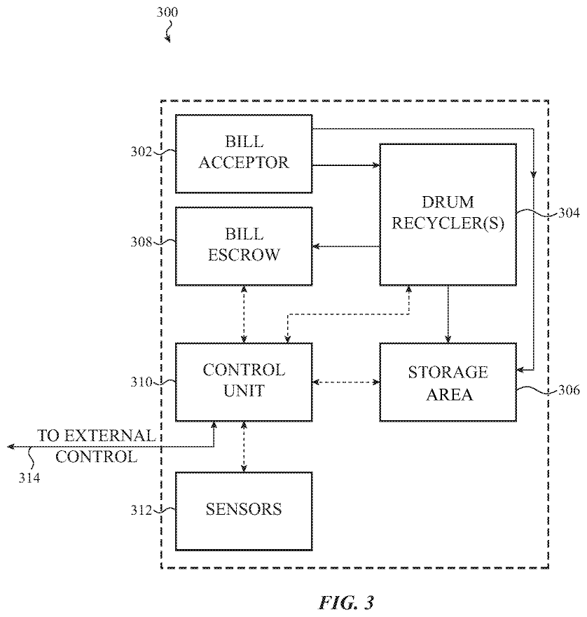

FIG. 3 shows a functional block diagram of sections and components of one embodiment of a currency handling device 300. Other embodiments may have alternate configurations, and more or fewer sections and components. The currency handling device 300 has at least one bank note acceptor 302 operable to take in bills. The bank note acceptor 302 may also perform other intake or ejection operations. These include, but are not limited to, accepting credit or debit card payments, accepting other inputs (such as casino floor gaming tickets), dispensing bills, and dispensing printed receipts. The bank note acceptor 302 may be configured to validate bank notes and determine how valid bills are to be stored. The bank note acceptor 302 may be configured to pass bills (as indicated by the two solid lines) to one of the bill recyclers 304 or the bill storage area 306. The selection of where to pass bills may be made as described above in relation to the bank note acceptor 110, or by using additional and/or alternative criteria. In some embodiments, the bank note acceptor 302 may also be configured to eject bills received from the bill recyclers 304.

The currency handling device 300 may have one or more bill recyclers 304. As described previously, the bill recyclers may each have one or more S/R drums, which may be cylinders around which accepted bills can be wound for storage and possible subsequent dispensing. The currency handling device 300 may also have one or more bill storage areas 306. The bill storage area 306 may receive bills either from the bank note acceptor 302, any of the bill recyclers 304, or from an escrow section 308 (or “bill escrow”). The escrow section 308 may be configured to accept bills from any of the bill recyclers 304, and return some or all of the bills to the bill recyclers 304, or to the bill storage area 306, as part of the methods described previously, and below.

The currency handling device 300 may have a control unit 310 that may have communication links, as indicated by the dotted lines, with some or all of the various components and sections of the currency handling device 300. The control unit 310 may include one or more processors, microprocessors, microcontrollers, image processors, application specific integrated circuits, memories, interfaces, and other components as needed to interact with and control operations of the various components and sections of the currency handling device 300.

As an example, the control unit 310 may receive signals from the bank note acceptor 302 related to scans of an inserted bank note. Such a scan may be obtained from the bill scanner 105. The control unit may use various image processing algorithms to determine if the bill is a valid bank note. If the bill is not valid, the control unit may transmit one or more signals to the bank note acceptor 302 to cause the bill to be ejected, such as by reversing the direction of rotation of rollers 104a, 104b as in the currency handling device 100 described above.

The control unit 310 may additionally and/or alternatively control other operations of the bank note acceptor 302, such as causing a message to appear on a display screen, causing valid accepted bills to be routed to either the bill recyclers 304 or the bill storage area 306, and other operations.

The control unit 310 may have communication links to send and receive signals with the bill recyclers 304. As an example, the signals may be related to the number of bills on the various S/R drums of the bill recyclers 304. The control unit 310 may also receive signals related to a user input, as may have been entered on a touchpad or keypad of the bank note acceptor 302, and as a result send signals to cause one or more of the bill recyclers 304 to dispense bills to the user. The control unit 310 may also maintain, such as in an internal memory, a record of the number of bills on the S/R drums of the bill recyclers 304, and the time such bills have been stored.

The control unit 310 may also have a communication link with the bill storage area 306, such as to receive signals related to how full the bill storage area is. The control unit 310 may also have a communication link with the escrow section 308, such as to control movement of bills from and to the bill recyclers 304 during operation of the methods described below.

The control unit 310 may have an external communication link 314, such as to a separate control or data center, to accept either automated or manual entry of operations to be performed by the currency handling device 300. The external communication link 314 may be any of various technologies, including, but not limited to, Ethernet, cable technologies, wired links, fiber optic technologies, and radio transmission technologies (such as WiFi, cellular, or near field communication methods). The control unit 310 may also use the external communication link 314 to transmit messages, such as regarding the status of the currency handling device 300 or its components or sections. For example, messages may be sent related to operational status (e.g., jammed or in service), number of bills on the various S/R drums of the bill recyclers 304 or in the bill storage area 306, among other types of messages.

The currency handling device 300 may also include one or more sensors 312. Some or all of the sensors 312 may be components of the other sections of the currency handling device 300, such as internal to a bill recycler 304. The sensors may detect environmental parameters, such as humidity and/or temperature, or physical properties, such as vibration, weight (such as of the bill storage area), or yet other properties. The one or more sensors may have a communication link with the control unit 310 over which the respective sensed parameter or property can be transmitted. The control unit 310 may receive the sensors' signals and may modify operation of the currency handling device 300 or its components or sections based on the sensor data contained in the signals. For example, a record of low humidity may indicate that the bills on the S/R drums of the bill recyclers may be at risk of becoming drier and stiffer sooner than expected, and so trigger the bill recycling methods described below. Similarly, a record of higher than expected temperature may also make the bills drier sooner than expected. Also, a record that the S/R drum has had a greater than expected number of bills stored for a certain time interval may imply that the innermost bills have been subjected to greater than expected deforming pressure. These further examples may also trigger the bill recycling methods described below.

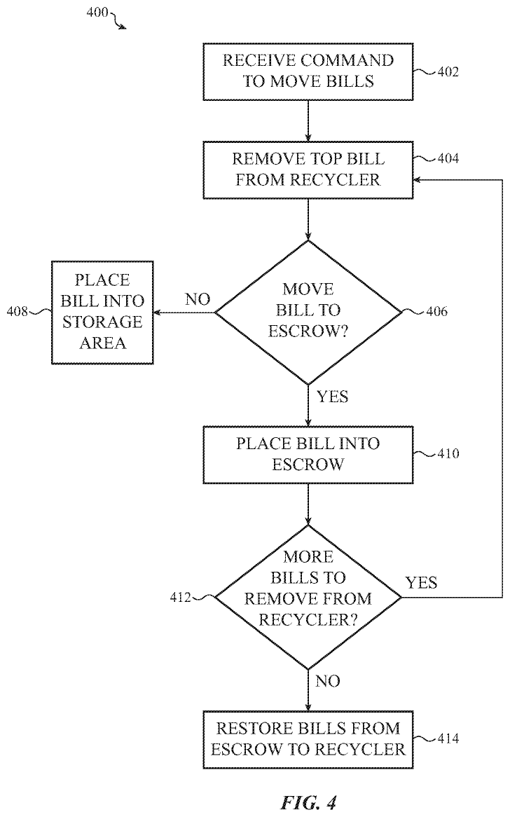

FIG. 4 shows a flow chart of a method 400 for bill recycling that may be used as part of the operations of any of the currency handling devices described herein having an escrow section and a bill recycler. The method may be controlled by a control unit of the currency handling device, such as control unit 310 described previously.

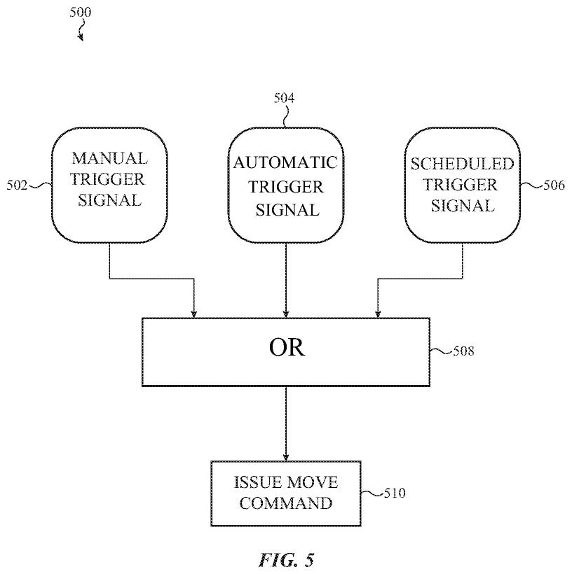

At stage 402, the method 400 is initiated when the bill recycler receives a command to initiate bill recycling and begin moving bills from an S/R drum to the escrow section. The command may arise in any of the ways described below in relation to FIG. 5. The command may be received at the currency handling device from an external source, or may be generated by a control unit of the currency handling device, such as control unit 310 as described previously. The command may also specify which S/R drum and bill recycler is to undergo the bill recycling method 400.

At stage 404, an outermost bill stored on the specified S/R drum is removed from the S/R drum. At stage 406, the bill is evaluated to determine where it should eventually be placed. Either the specified bill recycler or the escrow section may include a bill scanner, such as bill scanner 105 described previously, or another detection component operable to determine the wear or deformation status of the bill. Additionally and/or alternatively, in some embodiments a control unit (either in the currency handling device or in a separate control system) may determine the status based on at least one of: a record of initial wear or deformation status determined at the bill's input; a record of environmental factors within the currency handling device or bill recycler; a record of the length of time the bill has been on the S/R drum; or other factors.

At stage 406, the bill is selected either for movement to the storage area, or for temporary storage in the escrow section. In the former case, at stage 408 the bill is moved into the storage area. In the latter case, at stage 410 the bill is moved into the escrow section.

At stage 412, the method 400 determines if more bills are to be removed from the bill recycler. In one case, a negative answer (i.e., that no more bills are to be removed) may occur if the S/R drum has been emptied of bills. In other cases, a negative answer may occur even if bills still remain on the S/R drum, but the control unit needs to interrupt the process. This may occur if the escrow section is full, if it is known that only a certain number of outermost bills are likely to have too much wear or deformation, if the currency handling device needs to become available to users, or for other reasons.

At stage 412, if the method determines that more bills are to be removed from the S/R drum, the method 400 returns to stage 404 and iterates the process for the next bill available on the S/R drum. Such iteration may proceed until a negative answer at stage 412 occurs. When a negative answer occurs at stage 412, the method 400 advances to stage 414.

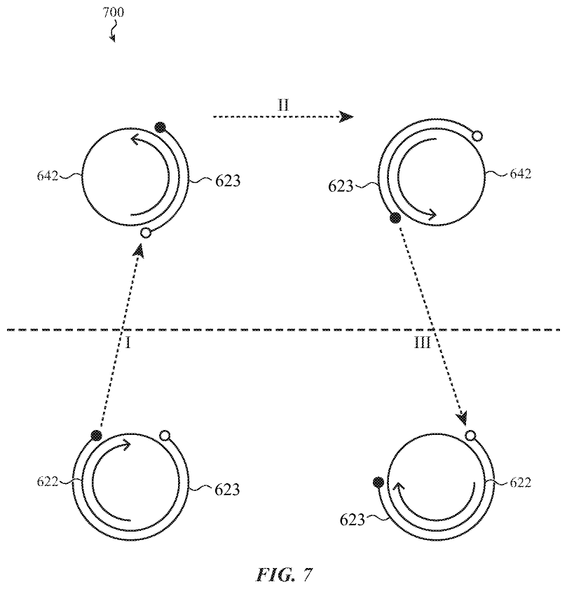

At stage 414, the bills that have been placed into the escrow section are restored to the specified S/R drum. As noted, depending on the configuration and process used by the escrow section, the bills may be restored in a different order from which they were removed, or with a different curvature orientation, as explained further below with respect to FIG. 7.

FIG. 5 illustrates a decision process 500 that may be used to trigger a command to move bills in a currency handling device, such as the command discussed in relation to stage 402 of the bill recycling method 400 just described. The decision process 500 may be performed by a control unit, such as control unit 310 of the currency handling device 300, or by a separate computer or processing device having a communication link to the currency handling device. The decision process 500 may be implemented in software, firmware, or hardware.

The decision process 500 may have a decision block 508 configured to accept different types of trigger signal inputs. A first type of trigger signal input is the manual trigger signal 502. An operator of the currency handling device may directly access the currency handling device and input the trigger signal command. This may be done by the operator through a secure access directly at the currency handling device, such as a key pad or touch pad. Alternatively, the operator may issue the command to move bills over a communication link to the currency handling device, such as the external communication link 314 as described in relation to FIG. 3.

A second type of trigger signal input is the automatic trigger signal 504. The automatic trigger signal 504 may be internally generated, such as by the control unit 310 of the currency handling device 300, or externally generated by a computer or processing unit separate from the currency handling device and communicated to the currency handling device. The automatic trigger signal 504 may result from a program of the processing unit that takes into account information related to the condition of the bills on an S/R drum, environmental factors, and/or other factors.

The automatic trigger signal 504 may arise when the length of time that at least one bill has been wrapped on an S/R drum exceeds a maximum allowable time. Such a maximum allowable time may be initially determined experimentally and programmed into the currency handling device (such as in the control unit 310), and may be altered or adjusted based on environmental parameters or properties, such as may be measured by the sensors 312 of the currency handling device 300. Adjustments to the maximum allowable time may also use records of conditions, such as wear, of the bills on the S/R drums. For example, if upon insertion, a bill is determined (such as by control unit 310) to be only somewhat acceptable for storage on an S/R drum, the maximum allowable time may be reduced, whereas if the bill had been in new condition, the maximum allowable time may not need to be reduced. Other recorded conditions that may alter a maximum allowable time include temperature and/or humidity, as described previously.

A third type of trigger signal to the decision block 508 is the scheduled trigger signal 506. The currency handling device may be programmed to apply a bill recycling method on a fixed schedule, such as at programmed or regular time intervals. This may allow for operational simplicity and convenience for the operators of the currency handling device. The time interval(s) may be programmed based on a worst case allowable maximum time for a bill to be on an S/R drum, and/or other criteria. If a manual trigger signal 502 is sent between scheduled trigger signals 506, the schedule for the scheduled trigger signals 506 may be reset or restarted.

Decision block 508 may be configured to receive any combination of these, or still other, trigger signals. The decision block 508 may execute an OR operation so that even a single type of received trigger signal will cause decision block 508 to issue a MOVE command 510 to initiate a bill recycling method.

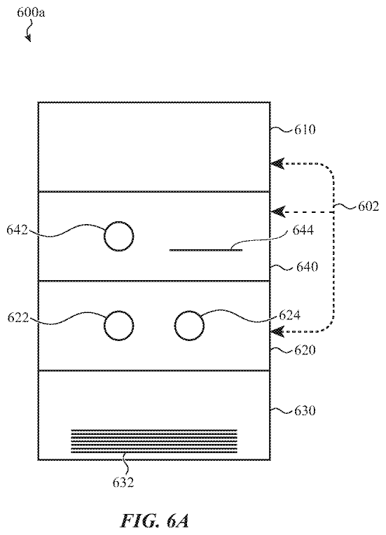

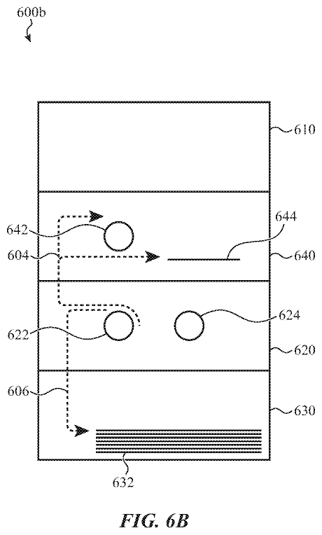

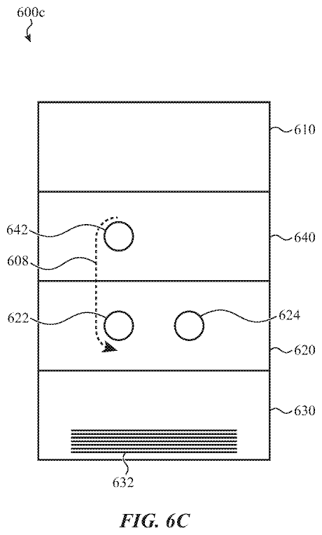

FIGS. 6A-C illustrate states 600a-c of a currency handling device as bills are moved between components of the currency handling device during a bill recycling method. The currency handling device includes a control section 610, such as may include control unit 310, and/or a bank note acceptor, such as bank note acceptor 110, or may be or have a link, such as external communication link 314, to external controls. The currency handling device also includes a bill recycler 620 having S/R drums 622 and 624. The currency handling device also has an escrow section 640 having an escrow storage drum 642 and an alternate storage component 644. The currency handling device also includes a storage area 630 operable to receive and store bills 632. The configuration of the currency handling device shown in FIG. 6A is an example only: the movements of bills to be described can apply to currency handling devices having alternate configurations.

FIG. 6A shows a configuration of an initial state 600a of the currency handling device. A move command, such as described in relation to FIG. 5, is received at control section 610 to initiate a bill recycling operation, such as by the method 400. Signals 602 may be transmitted between the control section 610 and the bill recycler 620 and the escrow section 640. The signals may give information to identify S/R drum 622 and bill recycler 620 to undergo the bill recycling operation, to select which of escrow storage drum 642 and/or alternate storage component 644 is to be used, operational status of the various sections, amount or status of the bills on the S/R drum 622, environmental factors of the various sections, and/or other information. The signals 602 may also include control signals to operate the S/R drum 622, the escrow storage drum 642 and/or alternate storage component 644, the various conveyor or movement components (not shown) that move the bills, and the like.

FIG. 6B illustrates a second state 600b of a currency handling device as one or more bills are being removed, as in stage 404 of method 400, from the S/R drum 622. As each bill is removed, a determination is made, as described previously, whether the bill is to be moved into the storage area 630 or into the escrow section 640. In the former case, the current bill is moved along conveyance path 606 into the storage area 630. In the latter case, the bill is moved along conveyance path 604 to either the escrow storage drum 642 or the alternate storage component 644.

In some embodiments, both the escrow storage drum 642 and the alternate storage component 644 may be used. For example, the S/R drum 622 may be holding more bills than either the escrow storage drum 642 or the alternate storage component 644 could store separately. In another example, innermost bills wrapped on the S/R drum 622 may be moved to the escrow storage drum 642 with the reverse orientation, as described in FIG. 7, to at least partially reverse bending deformation, while the outermost bills on the S/R drum 622 can be moved onto a flat stack of bills stored in the alternate storage component 644.

FIG. 6C illustrates a third state 600c of the currency handling device as bills are being restored from the escrow storage drum 642 to the S/R drum 622. The bills may be moved along the conveyance path 608 to be wrapped or stored on the S/R drum 622.

Variations of the methods and processes described above will be apparent to one skilled in the art. An example of such variations includes returning some or all of the bills moved to the escrow storage drum 642 to an S/R drum different from their originating S/R drum 622. This may be useful for balancing the number of bills of a certain denomination stored on two (or more) S/R drums used to store bills of that denomination.

FIG. 7 illustrates a configuration 700 that may be used in any of the currency handling devices with any escrow section having an escrow storage drum as described previously. For convenience only, the configuration 700 will be described in relation to the currency handling device shown in FIG. 6C having the escrow section 640. In the configuration 700, when bills are moved from the S/R drum 622 onto the escrow storage drum 642, the bills are wound to have an opposite orientation. In this way, curling of the bill substrate can be counteracted.

In the configuration 700, the S/R drum 622 initially has bill 623 wrapped on it as shown, with alternate ends of the bill referenced by the solid and open circles. In either of dispensing or of movement of bills to the escrow storage drum 642, the S/R drum 622 rotates clockwise. During stage I of a movement of bills to the escrow section, the bill is unspooled and moved toward and onto the escrow storage drum 642. The escrow storage drum 642 is configured to rotate counterclockwise and wrap the bill 623. The bill 623 now is stored on the escrow storage drum 642 with a bend or curl opposite to that which it had when stored on the S/R drum 622, as indicated by the referenced ends of the bill 623. At stage II of the movement of bills to the escrow section, the escrow storage drum 642 rotates counterclockwise as needed, such as to obtain a complete wrapping of the bill 623 onto itself, to receive further bills from the S/R drum 622, or for other reasons. The opposite bend or curl of the bill 623 as stored on the escrow storage drum 642 may, at least in part, reverse, counteract, or undo any curling or bending the bill 623 may have had impressed by its original direction of wrapping on the S/R drum 622.

At stage III of the movement of bills to the escrow section, the various bills that were temporarily stored on the escrow storage drum 642 are to be returned to the S/R drum 622 of the drum recycler section. The movement of bill 623 onto the S/R drum 622 is such that it is received onto the S/R drum 622 to have its original direction of wrapping on the S/R drum 622.

In a variation of a movement of all bills from the S/R drum 622, the bills may be wrapped onto the escrow storage drum 642 with either the same direction of bending or wrapping as on the S/R drum 622. In this variation, for bill 623 to be received onto the escrow storage drum 642 with the same direction of bending, the escrow storage drum 642 would also be rotating clockwise.

Once all bills have been moved from the S/R drum 622 onto the escrow storage drum 642, in this variation the S/R drum 622 may reverse its direction of rotation. Then the bill 623 may be moved off the escrow storage drum 642 back to the S/R drum 622 to be received with a direction of bending or wrapping opposite to what it had originally before the movement operation. A drum recycler implementing this variation of reversing the rotation direction of the S/R drum 622 may be configured with an additional dispensing slot.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A method of operating a currency handling device that includes a bill recycler, a bill storage area, and an escrow section, the method comprising:
moving a bill from the bill recycler to the escrow section;
determining whether the bill is to be moved to the bill storage area;
moving the bill from the escrow section to the bill storage area in a case that it is determined that the bill is to be moved to the bill storage area; and
moving the bill from the escrow section to the bill recycler in a case that it is determined that the bill is not to be moved to the bill storage area.

2. The method of claim 1, further comprising repeating the method for each of a plurality of further bills stored on the bill recycler.

3. The method of claim 2, wherein the method of claim 2 is initiated by a signal received at the currency handling device.

4. The method of claim 3, wherein the signal received at the currency handling device is an operator-applied signal.

5. The method of claim 3, wherein the signal is a periodically applied signal.

6. The method of claim 3, wherein the signal received at the currency handling device is automatically generated based on at least one of a record of an environmental condition in the currency handling device or a quantity of bills stored on the bill recycler.

7. The method of claim 1, wherein the determination that the bill is to be moved to the bill storage area is based at least in part on a length of time the bill has been stored on the bill recycler.

8. The method of claim 1 wherein the determination that the bill is to be moved to the bill storage area is based at least on one of a substrate type of the bill, a physical size of the bill, and a wear condition of the bill.

9. The method of claim 8, wherein the wear condition includes one of a color condition of the bill and a presence of a tear in the bill.

10. A currency handling device comprising:
a bank note acceptor;
a bill recycler comprising a storage and recycling (S/R) drum;
an escrow section comprising an escrow storage drum; and
a bill storage area;
wherein:
the bank note acceptor is operable to receive a bank note and route the bank note for storage in one of the bill storage area or the S/R drum of the bill recycler; and
the currency handling device is operable to perform a set of operations that:
move the bank note from the bill recycler to the escrow section;
determine whether the bank note is to be moved to the bill storage area;
move the bank note from the escrow section to the bill storage area in a case that it is determined that the bank note is to be moved to the bill storage area; and
move the bank note from the escrow section to the bill recycler in a case that it is determined that the bank note is not to be moved to the bill storage area.

11. The currency handling device of claim 10, wherein the currency handling device is further operable to dispense the bank note from the bill recycler.

12. The currency handling device of claim 10, wherein the bank note acceptor comprises a bill validator operable to determine to which of the bill recycler and the bill storage area the bank note is to be routed.

13. The currency handling device of claim 10, further comprising a control unit operably linked with the bill recycler and the escrow section, and operable to coordinate the performance of the set of operations.

14. The currency handling device of claim 13, further comprising at least one sensor communicatively linked with the control unit, wherein:
the at least one sensor is configured to detect an environmental condition within the currency handling device; and
the detected environmental condition is one of a temperature and a humidity

15. The currency handling device of claim 14, wherein the control unit is operable to initiate the set of operations based on the detected environmental condition.

16. The currency handling device of claim 13, wherein:
the control unit comprises an external communication link to a control center separate from the currency handling device; and
the control unit is operable to receive a command from the control center to initiate the set of operations.

17. The currency handling device of claim 13, wherein the control unit makes the determination that the bank note is to be moved from the escrow section to the bill storage area based on one of an amount of time the bank note has been stored on the bill recycler and an amount of wear on the bank note.

18. The currency handling device of claim 13, wherein the control unit is configured to receive a manually entered input to initiate the set of operations from an operator.

19. The currency handling device of claim 10, wherein the control unit is configured to perform the set of operations according to a programmed schedule.

20. The currency handling device of claim 10, wherein the set of operations is repeated until no bills remain on the S/R drum of the bill recycler.
